(19) United States
(12) Patent Application Publication
(10) Pub. No.: US 2026/0237267 A1
(43) Pub. Date: Aug. 13, 2026

(54) METHODS AND SYSTEMS FOR RESKINNING VISUAL OBJECTS DISPLAYED IN ELECTRONIC GAMES

(71) Applicant: Aristocrat Technologies, Inc., Las Vegas, NV (US)

(72) Inventors: Marc-Olivier Polycar, Montreal (CA); Monica Brito, Laval (CA); Michelle Koren, Montreal (CA); Luz Toscano, Moraga, CA (US); David Moussa, Montreal (CA); Karen Lee, Longueuil (CA)

(21) Appl. No.: 19/053,275

(22) Filed: Feb. 13, 2025

(51) Int. Cl. G07F 17/32

(52) U.S. Cl. CPC G07F 17/3211

(57) ABSTRACT

Methods and systems for reskinning visual objects displayed in electronic games are provided. The methods include creating a master image file of the visual object, where the visual object includes (i) a single-gray color scheme, and (ii) at least one visual enhancement. The methods also include defining at least one color library including a plurality of colors where at least one color is associated with a triggering event within the electronic game. Additionally, the methods include adjusting the single-gray color scheme of the visual object included in the created master image file to a color scheme for the visual object. The color scheme includes the color(s) of the plurality of colors included in the color library. The methods further include displaying the adjusted, color scheme for the visual object in the electronic game.

### TECHNICAL FIELD

The field of disclosure relates generally to reskinning visual objects, and more specifically, to methods and system for reskinning visual objects displayed in electronic games using a master file of the visual objects including a single-gray color scheme.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a method for reskinning a visual object displayed in an electronic game is provided. The method includes creating a master image file of the visual object, the visual object included in the created master image file including: (i) a single-gray color scheme, and (ii) at least one visual enhancement; defining at least one color library for the visual object, the color library including a plurality of colors, at least one color of the plurality of colors associated with a triggering event within the electronic game; in response to determining the triggering event associated with the at least one color of the plurality of colors included in the color library occurred during the electronic game, adjusting the single-gray color scheme of the visual object included in the created master image file to a color scheme for the visual object, the color scheme including the at least one color of the plurality of colors included in the color library; and displaying the adjusted, color scheme for the visual object in the electronic game.

In another aspect, a non-transitory computer-readable storage medium with instructions stored thereon is provided. The instructions, in response to execution by at least one processor, cause the at least one processor to: create a master image file of a visual object displayed in an electronic game, the visual object included in the created master image file including: (i) a single-gray color scheme, and (ii) at least one visual enhancement; define at least one color library for the visual object, the color library including a plurality of colors, at least one color of the plurality of colors associated with a triggering event within the electronic game; in response to determining the triggering event associated with the at least one color of the plurality of colors included in the color library occurred during the electronic game, adjust the single-gray color scheme of the visual object included in the created master image file to a color scheme for the visual object, the color scheme including the at least one color of the plurality of colors included in the color library; and display the adjusted, color scheme for the visual object in the electronic game.

In an additional aspect, a system is provided. The system includes at least one memory for storing instruction; and a controller in communication with the at least one memory. The controller includes at least one processor, wherein when the instructions are executed by the at least one processor, the at least one processor is configured to: create a master image file of a visual object displayed in an electronic game, the visual object included in the created master image file including: (i) a single-gray color scheme, and (ii) at least one visual enhancement; define at least one color library for the visual object, the color library including a plurality of colors, at least one color of the plurality of colors associated with a triggering event within the electronic game; in response to determining the triggering event associated with the at least one color of the plurality of colors included in the color library occurred during the electronic game, adjust the single-gray color scheme of the visual object included in the created master image file to a color scheme for the visual object, the color scheme including the at least one color of the plurality of colors included in the color library; and display the adjusted, color scheme for the visual object in the electronic game.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is an illustrative example of layout or foundation for an electronic game including a plurality of visual objects, in accordance with the present disclosure.

FIG. 5A is an illustrative example of a visual object included in the electronic game shown in FIG. 4, in accordance with the present disclosure.

FIG. 5B is an illustrative example of a master image file of the visual object shown in FIG. 5A, in accordance with the present disclosure.

FIG. 6A is an illustrative example of a single atlas defining a plurality of selectable color pallets for visual objects included in the electronic game shown in FIG. 4, in accordance with the present disclosure.

FIG. 6B is an illustrative example of a single set of predefined hex colors for visual objects included in the electronic game shown in FIG. 4, in accordance with the present disclosure.

FIG. 7A is an illustrative example of a color gradient for one of the selectable color pallets defined in the single atlas shown in FIG. 6A, in accordance with the present disclosure.

FIGS. 7B and 7C are enlarged, illustrative examples of a first and second hex color included in single set of hex colors shown in FIG. 6B, in accordance with the present disclosure.

FIG. 8 is an illustrative example of the visual object shown in FIGS. 5A and 5B undergoing a reskinning process based on a color included in the color gradient shown in FIG. 7A, in accordance with the present disclosure.

FIG. 9A is another illustrative example of a visual object included in the electronic game shown in FIG. 4, in accordance with the present disclosure.

FIG. 9B is an illustrative example of a master image file of the visual object shown in FIG. 9A, in accordance with the present disclosure.

FIG. 9C is an enlarged illustrative example of a portion of the master image file including the visual object shown in FIG. 9B, in accordance with the present disclosure.

FIG. 10 is an illustrative example of the visual object shown in FIGS. 9A and 9B undergoing a reskinning process based on the color gradient shown in FIG. 7A, in accordance with the present disclosure.

FIG. 11 is an illustrative example of the combined, reskinned visual objects shown in FIGS. 8 and 10, respectively, in accordance with the present disclosure.

FIG. 12 is an example of a user interface or screenshot of a triggering event occurring on an electronic game including a plurality of visual objects, in accordance with the present disclosure.

FIGS. 13-15 are example user interfaces or screenshots of an electronic game including a plurality of reskinned visual objects, in accordance with the present disclosure.

FIG. 16 is an example method of reskinning visual objects including in electronic games, in accordance with the present disclosure.

### DETAILED DESCRIPTION

In some known electronic gaming systems, electronic games attempt to offer customizable experiences to the players. For example, sports-based electronic games may provide the player with the ability to select their favorite sports team, while other electronic games may allow the player to select a preferred color scheme or color pattern prior to playing the game. Selecting a specific team and/or a preferred color pattern increases excitement for player's and make games feel more personable. However, creating these customizable experiences requires that each distinct image or object displayed during the electronic game be rendered or created to include distinct colors and/or themes. That is, each object displayed during an electronic game includes an individual data file. Additionally, each instance in which an object is rendered to include a different color to match a favorite team or selectable color pattern, requires another data file of that object to be created. For example, where ten (10) objects are included in an electronic game and a player has the option of choosing between twenty (20) different color patterns—each color pattern including three (3) distinct colors—the minimum number of files to be created for the electronic game is 200 (e.g., 10 objects×20 color patterns×1 color per object=200).

In addition to a large number of files required, the size or memory space these files take up on a device's memory storage is also excessive. For example, it is common for semi-intricate, color images or objects to be between two (2) and ten (10) kilobytes (KB) in size. Continuing the example above, 200 data files at 2 KB a file results in approximately 400 KB of space required just for the image files alone. A need exists to address these limitations, while also improving on machine performance, memory storage, and the overall functioning of gaming devices.

The present disclosure discussed herein includes gaming devices that utilize processes for “reskinning” or colorizing visual objects displayed in electronic games based on player preferences and/or player selections. Specifically, single master image files for each visual object included in electronic games are created to reduce the size and/or number of files required by electronic games to provide players selectable options to vary the visuals or UI of electronic games during gameplay. For example, processes of reskinning visual objects and/or the use of layers in a single master image file for visual objects of electronic games allows for various objects in the electronic games to be reskinned and/or display a variety of selectable colors or color schemes, without the need to create individual image files having distinct colors for each object. The master image file of the visual objects includes a single-gray color scheme, which in turn reduces the size of the file data associated with the master image file (e.g., 1 KB). Furthermore, a single atlas defining a plurality of color schemes and/or selectable color pallets may be called upon and/or individually layered over the master image file to reskin or color the visual object during gameplay. This is contrary to creating a single distinct file for each color scheme. By comparison to the example above, a single master image file of a visual object included in electronic games can be approximately 1 KB in size, and each individual color scheme or selectable color pallet defined by the atlas may be 500 bytes. As such, to cover twenty (20) different color patterns for a single visual object using the reskinning processes discussed herein, two files are created (e.g., single master image file, single atlas), which require approximately 11 KB of memory space.

Moreover in the present disclosure discussed herein, each single master image and single atlas is exported into electronic games separately from one another. That is, the file defining the single atlas is stored separately from each master image file for each visual object displayed in electronic games. In some examples, the single atlas may be stored in a backend of the memory device or memory storage included in the gaming device. As a result, specific color pallets defined in the single atlas can be selected, pushed, and/or displayed in electronic games on an “as needed” or “on-demand basis.” This in turn reduces the processing load and/or processing requirement by the electronic device to run electronic games. Additionally, and as a result of the reduced file size and/or number of files used in electronic games including reskinnable visual objects discussed herein, transferring data relating to specific color pallets defined in the single atlas and stored in a backend of the memory device can occur near instantaneously and/or with minimal to no load time to reskin the visual objects.

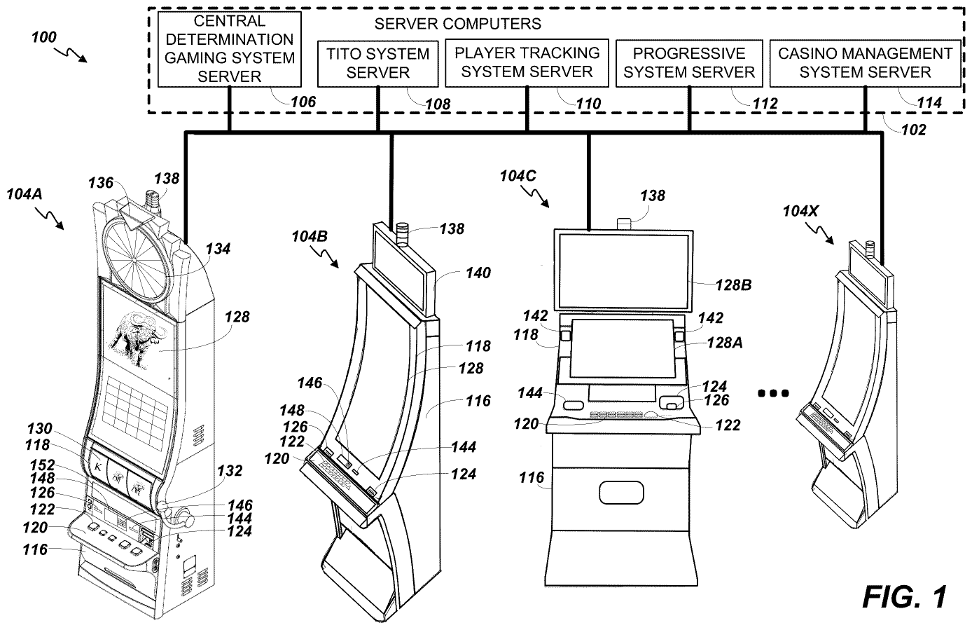

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

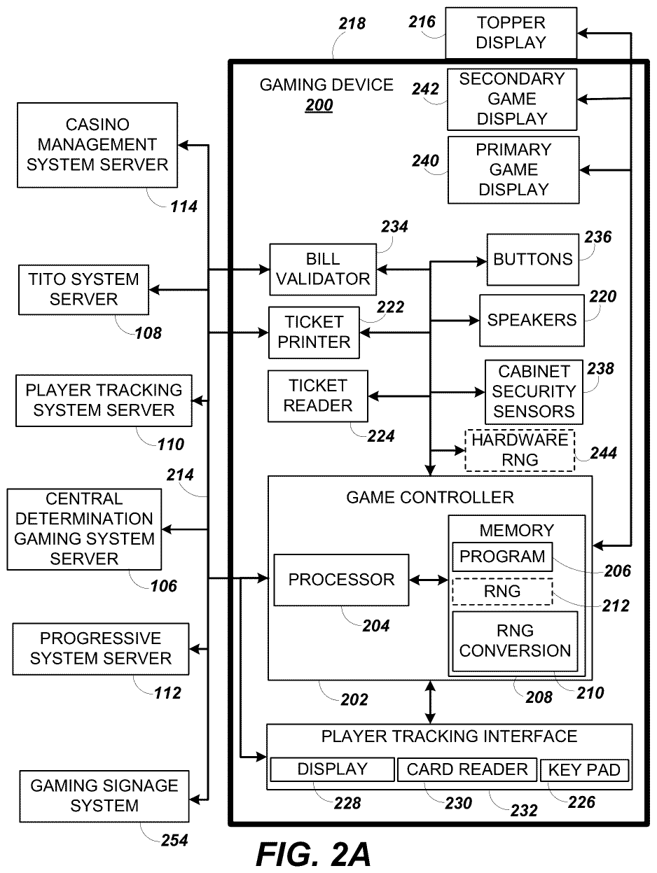

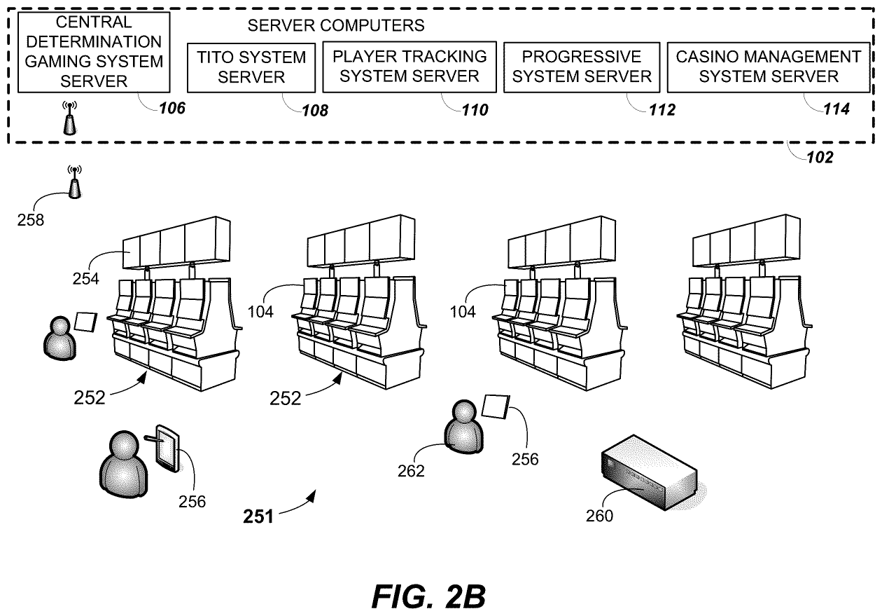

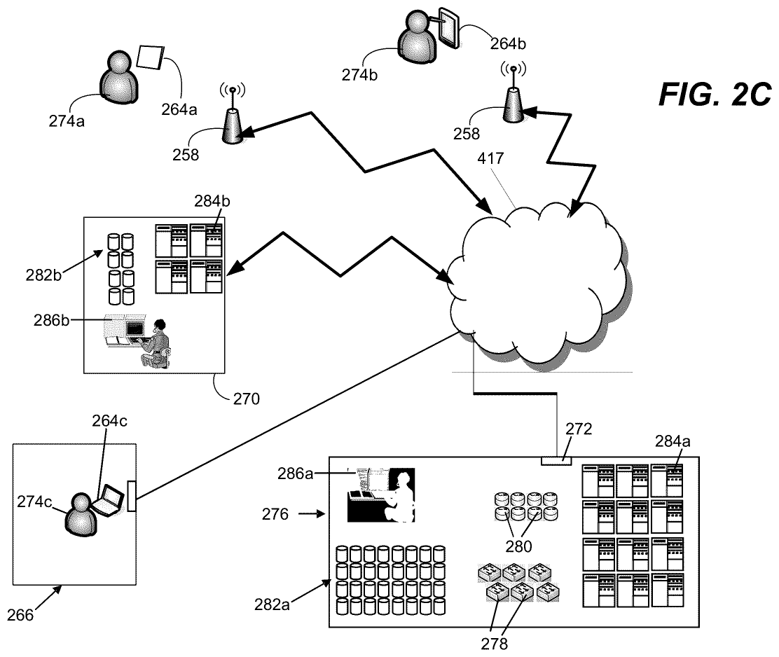

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., triggering events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

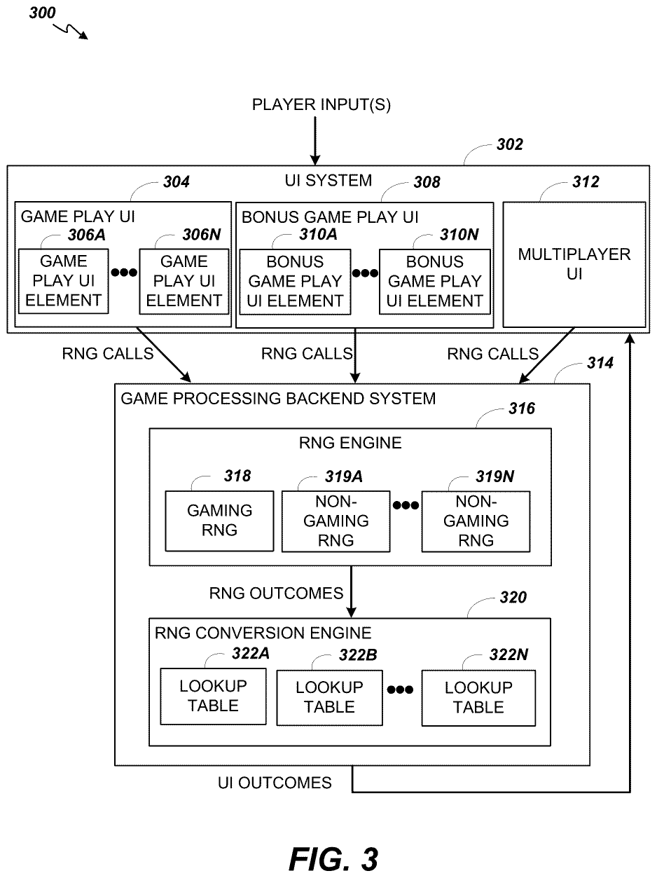

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

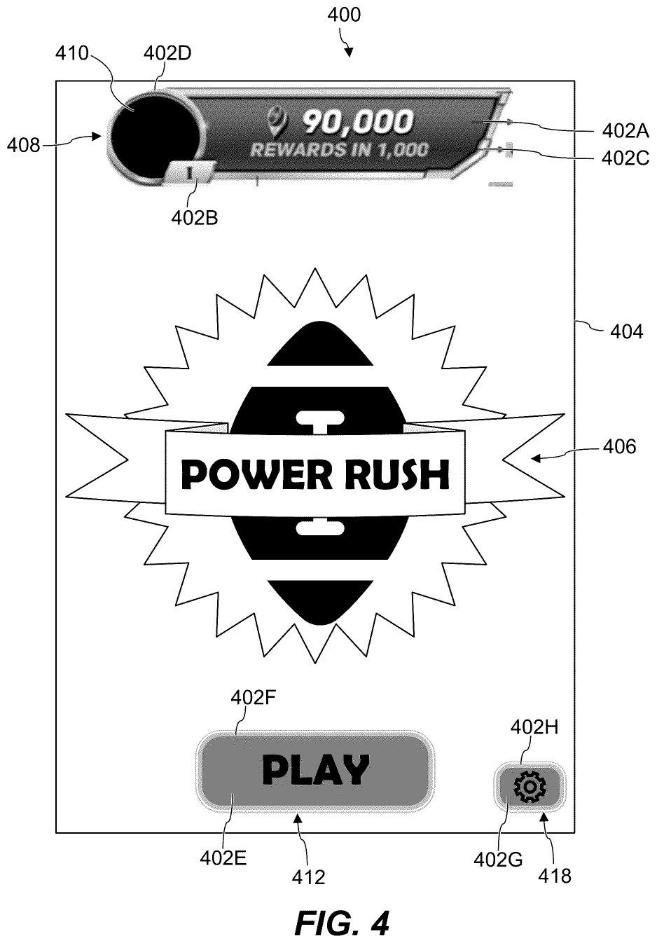

FIG. 4 is a visual depiction of an example electronic game 400 played on a gaming device (e.g., gaming devices 104A-104X in FIG. 1, and/or gaming device 200 and/or mobile gaming device 256 in FIG. 2B). Specifically, FIG. 4 shows a foundation or layout of various components and/or visual objects included in electronic game 400. As discussed herein, various visual objects 402 included in electronic game 400 and depicted in FIG. 4 are configured to be “reskinned” or colorized based on, at least in part, a player preference or player selection while playing electronic game 400. As such, the color scheme (e.g., monochromatic color scheme, grayscale color scheme) for each visual object 402 of electronic game 400, as depicted in FIG. 4, may not be presented to a player of electronic game 400, but rather is shown and discussed herein for purposes of describing the reskinning of visual objects 402 within electronic game 400.

In example implementations, the electronic game 400 is a Class II (e.g., bingo) game, a Class III or Las-Vegas style game, or a “free” online or e-game played over the internet. In various implementations, electronic game 400 may be implemented to present an outcome of any suitable game of chance. Specific details of the type of game presented using the electronic game 400 are not central to an understanding of the present disclosure. However, additional detail related to at least one implementation (e.g., an implementation employing a base reel game to present a primary bingo-based or Class II game outcome) may be obtained with reference to U.S. Published Patent Application No. 2012/0270638, filed Apr. 20, 2011, and entitled GAMING MACHINE WITH FREE PLAY BONUS MODE PRESENTING ONLY WINNING OUTCOMES, the disclosure of which is hereby incorporated by reference herein in its entirety.

Electronic game 400 may be initiated on a gaming device 104A-104X, 200 and/or mobile gaming device 256. For example, a player may fund electronic game 400 via bill validator 234 and/or ticket reader 224. Once funded, electronic game 400 (e.g., “POWER RUSH”) may commence. In other examples where electronic game 400 is configured as an e-game played over the internet and/or on mobile gaming device 256, electronic game 400 may be initiated by opening an opening an app stored on mobile gaming device 256.

Electronic game 400 may be played on multiple displays, such as the primary display device 404 and/or a secondary display. However, in other implementations, electronic game 400 may be played on a single display and/or on greater than two displays. Additionally, display device 404 can be configured as a touch enabled display device to allow the player to engage with and/or play electronic game 400 when displayed on touch enabled display device 404. For example, where the gaming device is formed as mobile gaming device 256 (see, FIG. 2B), display device 404 includes mobile gaming device's 256 touch screen or screens. As discussed herein, the user or player may touch display device 404 to operate and/or interact with electronic game 400 during game play. Touch enabled display device 404 (and/or controller 202/processor 204) may detect, recognize, and/or identify the player's touch, and determine the player's various interactions and/or selections during gameplay.

Electronic game 400 also includes a plurality of visual components 406 relating to electronic game 400. For example, component 406 includes a graphic representing electronic game 400 displayed on display device 404 during gameplay. As discussed herein visual components 406 of electronic game 400 may be universal and/or consistent throughout electronic game 400, regardless of the player preference or player selection while playing electronic game 400. For example, the presented color scheme of the graphic forming component 406 may be consistent and/or unaltered during gameplay of electronic game 400, regardless of player sections while playing electronic game 400 and/or regardless of a color scheme of visual objects 402 also displayed or depicted in electronic game 400.

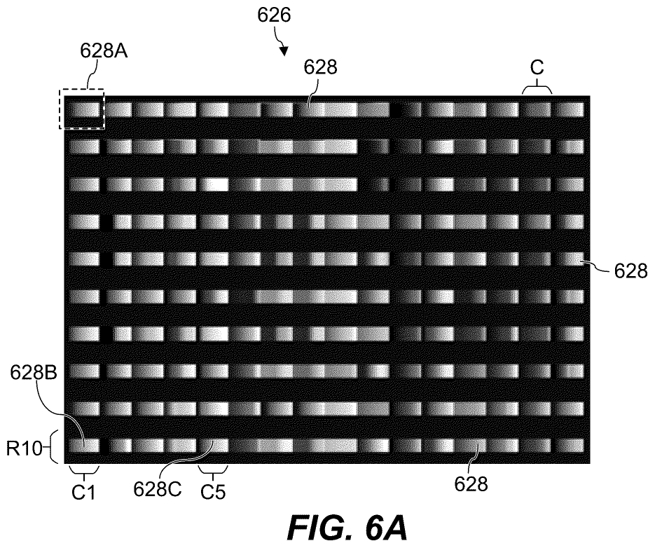

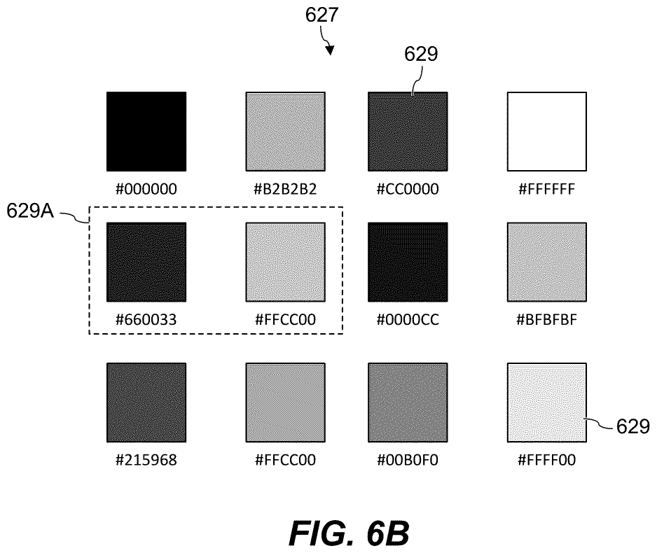

Visual objects 402 of electronic game 400 may be configurable to be reskinned and/or have adjustable or selectable color schemes applied during gameplay. That is, visual objects 402 of electronic game 400 include any object, graphic, and/or user interface (UI) portion of electronic game 400 that is configured to be “reskinned” or colorized based on, at least in part, a player preference or player selection while playing the electronic game (see, FIGS. 6-8). Additionally, visual objects 402 may be combined to form various portions of electronic game 400. For example, and as shown in FIG. 4, visual objects 402A, 402B, 402C, 402D collective form a game progress meter 408 depicted on display device 404. Progress meter 408 displays a progress value accrued by the player while playing electronic game 400. In the example, visual object 402A is a base object of progress meter 408 displayed in electronic game 400, where base object is configured to provide a reskinnable background for progress meter 408. Visual object 402B is a plaque object of progress meter 408 configured to display a player's level (e.g., “I”) for electronic game 400, while visual objects 402C, 402D are frame or boarder objects of progress meter 408 displayed in electronic game 400. Similar to visual object 402A, visual objects 402B, 402C, 402D are configurable to provide a reskinnable plaque object or frame object for progress meter 408. Visual object 402C formed as a frame object substantially surrounds the base object or visual object 402A, while frame object/visual object 402D is positioned adjacent distinct, visual objects 402A, 402C. Additionally as discussed herein, visual object 402D formed as a frame object surrounds an interchangeable graphic area 410 of progress meter 408. As discussed herein, interchangeable graphic area 410 can include a graphic or image associated with a selection made by the player while playing electronic game 400.

As shown in FIG. 4, visual objects 402E, 402F form a play button 412 of electronic game 400. More specifically, visual object 402E is a base object of play button 412 displayed in electronic game 400, where base object is configured to provide a reskinnable background for play button 412. Additionally, visual object 402F is a frame or boarder object of play button 412 displayed in electronic game 400. Visual objects 402G, 402H form a settings button 418 of electronic game 400. In the example, visual object 402G is a base object of settings button 418 displayed in electronic game 400, and visual object 402H is a frame or boarder object of settings button 418.

As discussed herein, various visual objects 402 (e.g., 402A-402h) included in electronic game 400 and depicted in FIG. 4 are configured to be “reskinned” or colorized based on, at least in part, a player preference or player selection while playing electronic game 400. The grayscale or single-gray color scheme for each visual object 402 of electronic game 400, as depicted in FIG. 4, may not be presented to a player of electronic game 400 during gameplay. That is, electronic game 400 may never depict visual objects 402 in the single-gray color scheme as shown in FIG. 4, but rather may reskin each visual object 402 to include a selected color scheme, prior to displaying electronic game 400 on display device 404 during gameplay. As discussed herein, each single-gray color schemed visual object 402 shown in FIG. 4 may include and/or represent a master image file stored within and manipulated by the gaming device (e.g., gaming device 104A-104X, 200 and/or mobile gaming device 256) to reskin each visual object 402 based on the player selection and/or preference. The use of master image files for each visual object 402 facilitates the gaming device's ability to reskin and/or provide various different color schemes for visual objects 402 of electronic game 400 without having to create individual graphic or image files for each visual object 402 for each distinct color included in the different color schemes.

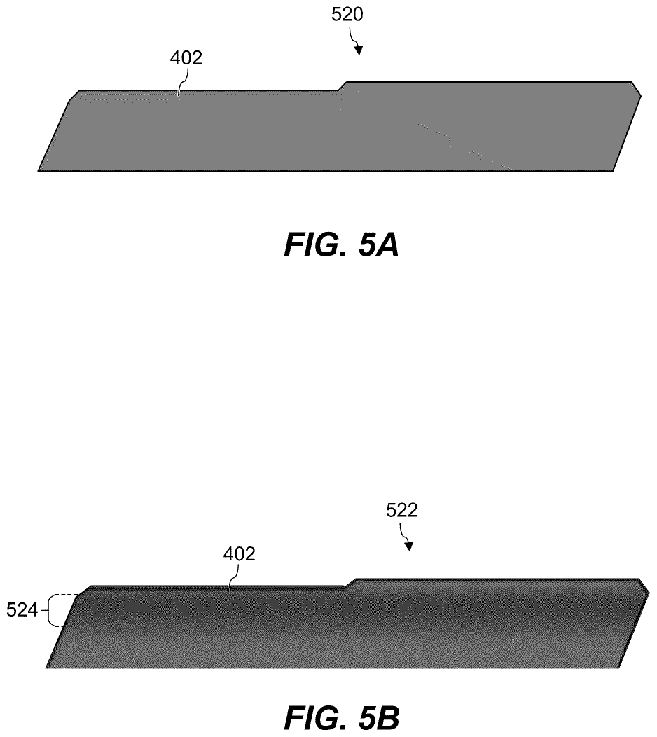

FIGS. 5A and 5B are example illustrations of visual object 402 included in electronic game 400, similar to those discussed herein. More specifically, FIG. 5A is an example illustration of visual object 402 prior to incorporating at least one visual enhancement (e.g., shading, blending), while FIG. 5B is an example illustration of visual object 402 after incorporating and/or including the at least one visual enhancement. As such, and as described herein, FIGS. 5A and 5B also illustrate example processes of forming a master image file (see, FIG. 5B) of visual object 402.

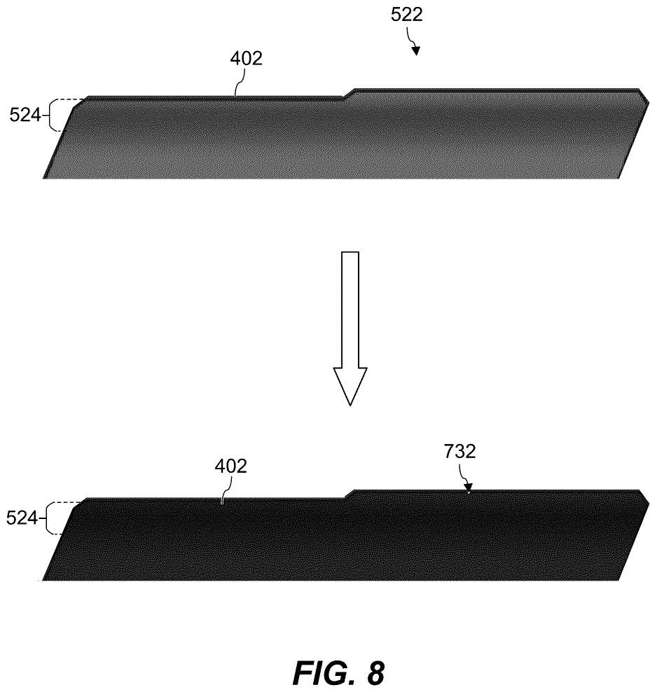

Visual object 402 includes any object, graphic, and/or user interface (UI) portion of an electronic game that is configured to be “reskinned” or colorized based on, at least in part, a player preference or player selection while playing the electronic game (see, FIG. 8). In the example shown in FIGS. 5A and 5B, visual object 402 is a base object displayed in electronic game 400, similar to that of base object 402A for progress meter 408 (see, FIG. 4). Although shown as a base object, it is to be understood that visual object 402 can include any portion of the UI of the electronic game 400 that is displayed during gameplay (e.g., frame object).

Additionally, visual object 402 displayed in FIG. 5A represents the “art file” 520 used to creating visual object 402. That is, art file 520 of visual object 402, as shown in FIG. 5A, represents the initial file or collection of data in which, for example a game designer or developer, created visual object 402 (e.g., base object) using any suitable computer-based program (e.g., Adobe Photoshop®). As shown in the example, visual object 402 included in art file 520 includes a single, gray color scheme. More specifically, the entirety of visual object 402 included in art file 520 is a solid or single color within a predefined grayscale color scheme (e.g., single-gray color). Additionally, or alternatively, the entirety of visual object 402 included in art file 520 is defined as a single material and/or having single material properties. For example, when creating visual object 402 included in art file 520, visual object 402 is created or designed to include material properties associated with a single material (e.g., metal, plastic, glass, etc.). Moreover, visual object 402 included in art file 520 is also depicted as being “flat” or not including at least one visual enhancement, such as shading or blending, as discussed herein.

Art file 520 can include any suitable file or collection of data in which, for example a game designer or developer, can create visual object 402 (e.g., base object). Additionally in examples, art file 520 also includes visual object 402 as a vector shape. That is, visual object 402 included in art file 520 is configured and/or formed as a vector shape, and as such, art file 520 including visual object 402 is formed as a vector image file.

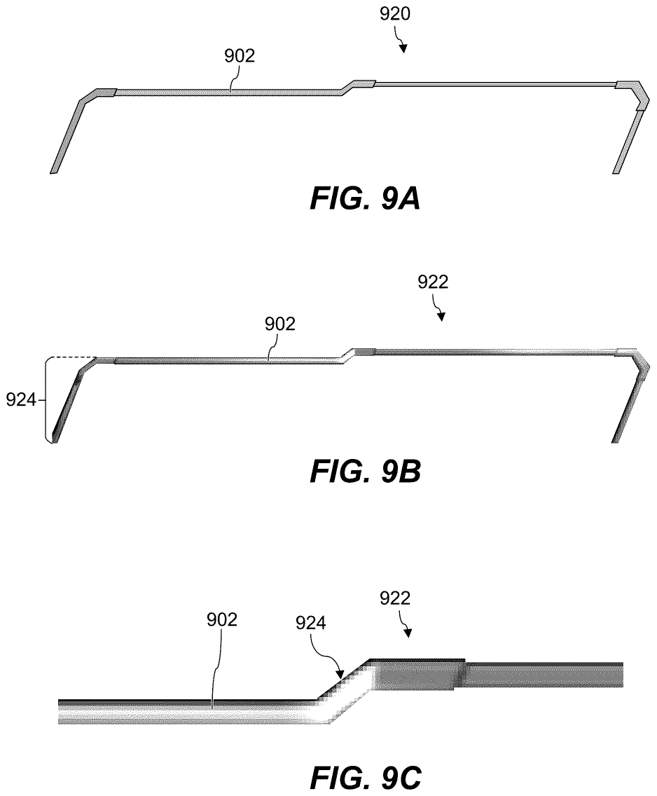

Art file 520 including visual object 402 is utilized to create a master image file 522, as shown in FIG. 5B (see also, FIG. 4). That is, using art file 520 including visual object 402 having the single color scheme (e.g., single, gray color) as a foundation, master image file 522 of visual object 402 can be created, generated, and/or rendered for use within electronic game 400. In an example, master image file 522 includes visual object 402 having the single color scheme, as well as at least one visual enhancement 524. More specifically, creating master image file 522 can include manipulating, modifying, and/or altering art file 520 including visual object 402 to additionally include at least one visual enhancement 524 on and/or over visual object 402. In the example shown in FIG. 5B, the at least one visual enhancement 524 included in master image file 522 includes a tint-effect or tinting with color blend of visual object 402-sometimes referred to as “shading” or “blending.” In other non-limiting examples described herein (see, FIGS. 9B and 9C), the at least one visual enhancement 524 included in master image file 522 includes a color gradient map for visual object 402.

In examples where art file 520 is formed as a vector image file and visual object 402 included in art file 520 is configured and/or formed as a vector shape, creating master image file 522 also includes creating at least one visual enhancement layer over the vector shape of visual object 402. Continuing examples described herein where art file 520 is created using Adobe Photoshop®, creating master image file 522 using art file 520 includes creating and/or applying at least one visual enhancement layer on and/or directly over visual object 402, formed as a vector shape. As a result, of overlaying the visual enhancement layer on visual object 402 of art file 520, master image file 522 includes at least two distinct layers—e.g., layer #1—vector shape of visual object 402 including single color scheme, layer #2—visual enhancement layer. In the example shown in FIG. 5B, the visual enhancement layer includes a tint-effect layer created, applied, and/or formed over the vector shape of visual object 402 including the single color scheme. As shown in FIG. 5B, as well as FIG. 8, the covering, overlaying, and/or inclusion of visual enhancement layer (e.g., tint-effect layer) within master image file 522 provides additional visual depth and/or three-dimensional perspective for visual object 402 without requiring additional colors and/or color gradients.

As discussed herein, by creating master image file 522 including the vector shape of visual object 402 and visual enhancement layer (e.g., tint-effect layer) over art file 520 of visual object 402, electronic game 400 can visual present and/or depict visual object 402 with various colors, based on player input and/or preference, without the need to generate distinct files of visual object 402 including each of the various colors.

FIGS. 6A and 6B are example illustrations of color references or color library used in coloring visual objects 402, as discussed herein. More specifically, FIG. 6A is an example illustration of a color library including a single atlas 626 defining a plurality of selectable color pallets 628, and FIG. 6B is an example illustration of a portion of a color library including a single set 627 of predetermined hex colors 629 including predefined color hex codes (e.g., “#000000”). Each of the selectable color pallets 628 defined in the single atlas 626 include at least one color, and is associated with a triggering event within electronic game 400. For example, and as discussed herein, prior to playing electronic game 400, a player may select and/or choose a favorite team (e.g., triggering event) linked to the theme of electronic game 400 (e.g., football themed games). Each color pallet 628 defined in the single atlas 626 is associated with an individual team that may be selected by the user during gameplay of electronic game 400. Color pallet 628 associated with the selected team may subsequently be used for reskinning master image files 522 for at least one visual object 402 displayed in electronic game 400.

In another exemplary embodiment, each row (R) within single atlas 626 corresponds to a collection, plurality, and/or predefined group of color pallets 628 that are associated with a single triggering event, while each column (C) within single atlas 626 corresponds to a distinct visual object 402 displayed in electronic game 400. Continuing the examples discussed herein where the triggering event includes selecting a favorite team linked to the theme of electronic game 400 (e.g., football themed games), each of the group of color pallets 628 included in a single row (R) within single atlas 626 are associated with a selected team. As such, when a player selects a team associated with the tenth row (R10) within single atlas 626, each of the group of color pallets 628 in the single, selected row (R10) are subsequently used for reskinning master image files 522 for a plurality of visual objects 402 displayed in electronic game 400. Additionally, a first visual object 402 displayed in the electronic game 400 and corresponding to the first column (C1) in single atlas 626 is reskinned using the single color pallet 628B in the selected row (R10) and first column (C1), while a distinct or fifth visual object 402 corresponding to the fifth column (C5) in single atlas 626 is reskinned using the distinct single color pallet 628C in the selected row (R10) and fifth column (C5).

Similarly, each of the selectable hex colors 629 defined in the single set 627 includes at least one color, and is associated with a triggering event within electronic game 400. For example, and as discussed herein, at least one hex color 629 included in the single set 627 of hex colors is associated with an individual team that may be selected by a user during gameplay of electronic game 400. As such, when a player selects and/or chooses a favorite team (e.g., triggering event) linked to the theme of electronic game 400 (e.g., football themed games), the at least one hex color 629 associated with the selected team may subsequently be used for reskinning master image files 522 for at least one visual object 402 displayed in electronic game 400.

Similar to art file 520, single atlas 626 and the distinct color pallets 628 defined therein, as well as single set 627 of hex colors 629, each represent a file or collection of data in which, for example a game designer or developer, created each of the distinct color pallets/hex colors using any suitable computer-based program (e.g., Adobe Photoshop®). For example, a designer or developer can create a plurality of distinct color pallets 628 for single atlas 626, where each of the plurality of color pallets 628 includes at least one color and is associated with a distinct triggering event (e.g., selectable teams). Color pallets 628 include a 32×8 pixel formation. However, it is understood that each color pallet defined within single atlas 626 can include more or less pixels. Additionally, single atlas 626 can define any suitable number of color pallets 628 thereon, where the number of color pallets 628 is dependent on, at least in part, the number of triggering events (e.g., number of teams) included in electronic game 400. Additional in exemplary embodiments, a designer or developer can identify and/or define a plurality of hex colors 629 for single set 627, where at least one of the plurality of hex colors 629 includes at least one color (e.g., primary color, secondary color) associated with a distinct triggering event (e.g., selectable teams). Single set 627 can define any suitable number of hex colors 629 therein, where the number of hex colors 629 is dependent on, at least in part, the number of triggering events (e.g., number of teams) included in electronic game 400.

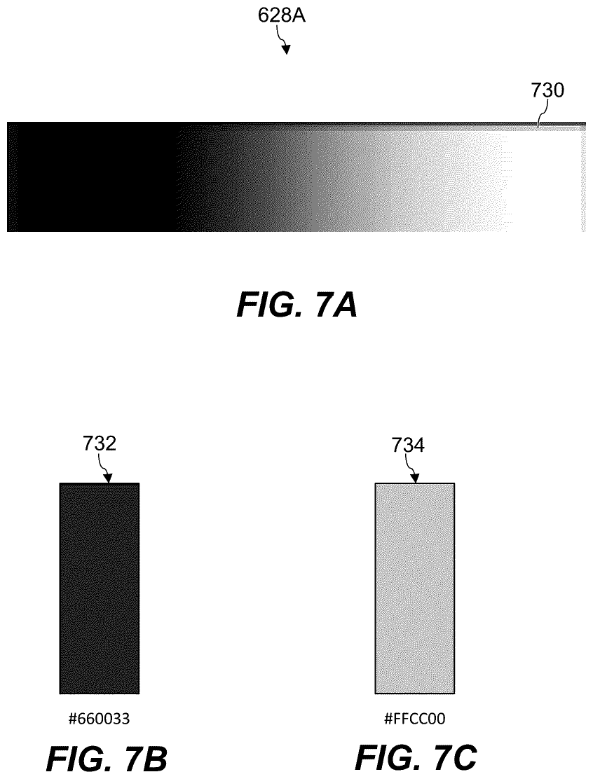

FIG. 7A is an enlarge view of the illustrative example of first color pallet 628A defined within single atlas 626. As described herein, each of the selectable color pallets 628 defined in the single atlas 626 include at least one color. In the example shown in FIG. 7A, first selectable color pallet 628A includes a color gradient 730 formed from a plurality of colors. Each of the colors included in color gradient 730 of selectable color pallet 628A is associated with a single triggering event (e.g., a selectable team) included within electronic game 400 (see, FIGS. 4 and 12-15). The color gradient 730 of first color pallet 628A define a pallet-specific color scheme that is used to reskin visual objects 402, as discussed herein.

FIGS. 7B and 7C are enlarged views of the illustrative examples of hex colors 629A (see, FIG. 6B) included in single set 627 of hex colors 629. Each hex color 629A of single set 627 is associated with a single triggering event (e.g., a selectable team) included within electronic game 400, as discussed herein. Additionally, and in exemplary embodiments, the triggering event associated with hex colors 629A of single set 627 is similar and/or identical to the single triggering event associated with first selectable color pallet 628A including color gradient 730. In an exemplary embodiment, hex colors 629A associated with the single triggering event identify, define, and/or include a first (primary) color 732 (see, FIG. 7B), and second (secondary) color 734 (see, FIG. 7C). Similar to color gradient 730, first color 732 and second color 734 defined by hex colors 629A in single set 627 of hex colors 629 include color(s) that are used to reskin visual objects 402, as discussed herein. Although two (2) colors are shown in FIGS. 7B and 7C, it is to be understood that any number of hex colors 629 can be included within single set 627 and associated with a single triggering event.

FIG. 8 is an illustrative example of visual object 402 undergoing a reskinning process using hex colors 629A of single set 627 of hex colors 629 of FIG. 6B. More specifically, FIG. 8 depicts master image file 522 of visual object 402 prior to being reskinned, as well as master image file 522 subsequent to being reskinned. As discussed herein, and prior to reskinning master image file 522, master image file 522 includes visual object 402 including a single color scheme (e.g., single, gray color), as well as visual enhancement 524 (e.g., tint-effect). However in response to determining a triggering event associated with hex colors 629A defined in single set 627 (see, FIG. 6B) occurs or is detected during electronic game 400, visual object 402 formed as a base object is reskinned and/or colorized. More specifically, the single color scheme of visual object 402 included in the created master image file 522 is adjusted, altered, modified, and/or changed to a single color scheme defined by the first or primary color 732 of hex colors 629A included in single set 627 of hex colors 629.

In the example shown in FIG. 8, the single color scheme for visual object 402 is based on and/or includes first (primary) color 732 included within and/or defined by hex colors 629A of single set 627 of hex colors 629. That is, the single color scheme of pre-skinned visual object 402 (e.g., single, gray color) is adjusted, modified, and/or changed to first (primary) color 732 when undergoing the reskinning process. Visual object 402 may only be reskinned to include and/or depict first (primary) color 732 as a result of the visual enhancement 524 included in master image file 522 including a tint-effect layer. In the example, and subsequent to the single triggering event associated with hex colors 629A occurring, the single-gray color scheme of visual object 402 included in the created master image file 522 is adjusted to first (primary) color 732 included in hex color 629A of single set 627 of hex colors 629.

Continuing examples described herein, Adobe Photoshop® may be used to facilitate the adjusting of visual object 402 from the grayscale color scheme included in master image file 522 to the pallet-specific color scheme associated with first selectable color pallet 628A, and more specifically, first (primary) color 732 of color gradient 730. For example, and with the use of individual layers and defined layer comps in Adobe Photoshop®, visual object 402 can be adjusted from a grayscale color to the pallet-specific color scheme. More specifically, an individual layer comp can be created and associated with each of the selectable color pallets 628 defined by single atlas 626. In example, each layer comp for each selectable color pallet 628 can also include an associated, individual layer having a corresponding color (e.g., first (primary) color 732) included in the color gradient 730 for selectable color pallets 628. The individual layers and layer comps can be included within and/or overlaid on master image file 522, and subsequently become “visible” when the specific layer comp is selected. In this instance, reskinning visual object 402 includes identifying a layer comp associated with the pallet-specific color scheme of first selectable color pallet 628A, and in turn making the associated layer having the corresponding first (primary) color 732 visible to overlay, cover, and/or visual replace the grayscale color scheme of the visual object 402 in master image file 522 with first (primary) color 732.

Although reskinned and/or colorized as described herein, master image file 522 remains intact and/or unchanged during the reskinning process. For example, and as shown in FIG. 8, although visual object 402 is reskinned to change the single color scheme (e.g., single gray color) to first (primary) color 732 included in hex colors 629A defined in single set 627 of hex colors 629, master image file 522, including art file 520 of visual object 402 and visual enhancement layer (e.g., tint-effect layer) remain unchanged, unaltered, and/or unmodified. Rather, individual layers for each layer comp associated with each of the hex colors 629 defined by single set 627 are merely overlayed and/or visible when reskinning visual object 402, as discussed herein.

FIGS. 9A-9C are additional example illustrations of visual object 902 included in electronic game 400 (see, FIG. 4). More specifically, FIG. 9A is an example illustration of visual object 902 prior to incorporating at least one visual enhancement, while FIG. 9B is an example illustration of visual object 902 after incorporating and/or including the at least one visual enhancement. Additionally, FIG. 9C is an enlarged view of a portion of visual object 902 illustrating a gradient map effect included thereon. As similarly described herein with respect to FIGS. 5A and 5B, FIGS. 9A and 9B illustrate example processes of forming a master image file 922 (see, FIG. 9B) of visual object 902.

In the example shown in FIGS. 9A and 9B, visual object 902 is a frame or boarder object displayed in electronic game 400, similar to that of frame object 902C for progress meter 408 (see, FIG. 4). Additionally, visual object 902 displayed in FIG. 9A represents the “art file” 920 used to creating visual object 902. That is, art file 920 of visual object 902, as shown in FIG. 9A, represents the initial file or collection of data in which, for example a game designer or developer, created visual object 902 (e.g., base object) using any suitable computer-based program (e.g., Adobe Photoshop®). As shown in the example, visual object 902 included in art file 920 includes a single color scheme. More specifically, the entirety of visual object 902 included in art file 920 is a solid or single color (e.g., gray). Additionally, or alternatively, the entirety of visual object 902 included in art file 920 is defined as a single material and/or having single material properties, as discussed herein. Moreover, visual object 902 included in art file 920 is also depicted as being “flat” or not including at least one visual enhancement, such as shading or blending, as discussed herein.

Art file 920 can include any suitable file or collection of data in which, for example a game designer or developer, can create visual object 902 (e.g., base object). Additionally in examples, art file 920 also includes visual object 902 as a vector shape. That is, visual object 902 included in art file 920 is configured and/or formed as a vector shape, and as such, art file 920 including visual object 902 is formed as a vector image file.

Art file 920 including visual object 902 is utilized to create a master image file 922, as shown in FIG. 9B (see also, FIG. 4). That is, using art file 920 including visual object 902 having the single-gray color scheme as a foundation, master image file 922 of visual object 902 can be created, generated, and/or rendered for use within electronic game 400. In an example, master image file 922 includes visual object 902 having the single color scheme (e.g., gray), as well as at least one visual enhancement924. More specifically, creating master image file 922 can include manipulating, modifying, and/or altering art file 920 including visual object 902 to additionally include at least one visual enhancement 924 on and/or over visual object 902. In the example shown in FIG. 9B, the at least one visual enhancement 924 included in master image file 922 includes a color gradient map or color gradient effect for visual object 902.

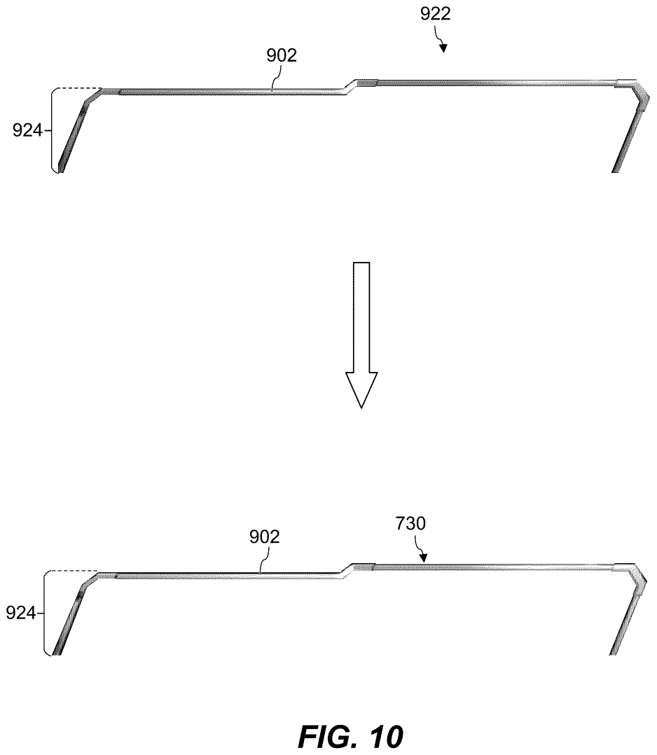

In examples where art file 920 is formed as a vector image file and visual object 902 included in art file 920 is configured and/or formed as a vector shape, creating master image file 922 also includes creating at least one visual enhancement layer over the vector shape of visual object 902. Continuing examples described herein, creating master image file 922 using art file 920 includes creating and/or applying at least one visual enhancement layer on and/or directly over visual object 902, formed as a vector shape. As a result, of overlaying the visual enhancement layer on visual object 902 of art file 920, master image file 922 includes at least two distinct layers—e.g., layer #1—vector shape of visual object 902 including single color scheme, layer #2—visual enhancement layer. In the example shown in FIG. 9B, the gradient map layer is created, applied, and/or formed over the vector shape of visual object 902 including the single color scheme (e.g., single gray color). As shown in FIG. 9B, as well as FIG. 10, the covering, overlaying, and/or inclusion of gradient map layer within master image file 922 provides additional visual depth and/or three-dimensional perspective for visual object 902 by introducing different hues of including in a predefined grayscale gradient. At least a portion of the different hues included in grayscale gradient and incorporated on visual object 902 included in master image file 922 are illustrated in the enlarged portion of master image file 922 shown in FIG. 9C.

FIG. 10 is an illustrative example of visual object 902 undergoing a reskinning process using first color pallet 628A of the plurality of color pallets 628 defined within single atlas 626 of FIG. 6A. More specifically, FIG. 10 depicts master image file 922 of visual object 902 prior to being reskinned, as well as master image file 922 subsequent to being reskinned. As discussed herein, and prior to reskinning master image file 922, visual object 902 includes a single, gray color scheme and visual enhancement 924 including a gradient map layer. In response to determining a triggering event associated with color pallet 628A defined within single atlas 626 occurs or is detected during electronic game 400, visual object 902 formed as the frame object is reskinned and/or colorized. More specifically, the color scheme of visual object 902 included in the created master image file 922 is adjusted, altered, modified, and/or changed to a pallet-specific color scheme.

In the example shown in FIG. 10, the pallet-specific color scheme for visual object 902 is based on and/or includes the various colors defined in color gradient 730 (see, FIG. 7A) included within first selectable color pallet 628A (see, FIG. 6). That is, visual object 902 is adjusted, modified, and/or changed to the plurality of colors defined by color gradient 730 of first selectable color pallet 628A, when undergoing the reskinning process. Visual object 902 may be reskinned to include and/or depict color gradient 730 as a result of the visual enhancement 924 included in master image file 922 including a gradient map layer. In the example, adjusting visual object 902 included in the created master image file 922 to the pallet-specific color scheme includes selecting color gradient 730 for the first selectable color pallet 628A included in single atlas 626, and subsequently changing the color scheme of visual object 902 to selected color gradient 730. Additionally, and because visual object 902 includes visual enhancement 924 formed as a gradient map, the various colors included in color gradient 730 for first selectable color pallet 628A are mapped, associated with, and/or corresponded to distinct portions of the gradient map included in visual enhancement 924. For example, darker colors included in color gradient 730 (e.g., black) replace darker shades of gray in the grayscale gradient map, while lighter colors (e.g., white) of color gradient 730 replace the lighter shades of gray in the grayscale gradient map included on visual object 902. Distinct colors included in color gradient 730 between the darkest and lightest colors (e.g., brown-hues, red-hues, yellow-hues, etc.), replace the shades of gray in the grayscale gradient map in between the darkest and lightest shades of the grayscale gradient map for visual object 902.

As discussed herein, first color pallet 628A of the plurality of color pallets 628 defined within single atlas 626 of FIG. 6A is selected and/or utilized to reskin visual object 902 as a result of first color pallet 628A being associated with the selected triggering event (e.g., selecting a favorite team). In another exemplary embodiment, first color pallet 628A is selected and/or utilized to reskin visual object 902 as a result of the selected triggering event corresponding to the first row (R) within single atlas 626 including a first group of color pallets 628, 628A, and visual object 902 corresponding to the first column (C) within single atlas 626.

Similar to examples described herein, Adobe Photoshop® may be used to facilitate the adjusting of visual object 902 from the grayscale color scheme included in master image file 922 to the pallet-specific color scheme associated with first selectable color pallet 628A, and more specifically, color gradient 730 included in first selectable color pallet 628A. For example, and with the use of individual layers and defined layer comps in Adobe Photoshop®, visual object 902 can be adjusted from a single-gray color to the pallet-specific color scheme. More specifically, an individual layer comp can be created and associated with each of the selectable color pallets 628 defined by single atlas 626. In example, each layer comp for each selectable color pallet 628 can also include an associated, individual layer having a corresponding color (e.g., color gradient 730) for selectable color pallets 628A. The individual layers and layer comps can be included within and/or overlaid on master image file 922, and subsequently become “visible” when the specific layer comp is selected. Additionally, the plurality of colors included in color gradient 730 of first selectable color pallet 628A is substantially matched with and/or correspond to the grayscale gradient used for visual enhancements 924 (e.g., gradient map) included in master image file 922. In this instance, reskinning visual object 902 includes identifying a layer comp associated with the pallet-specific color scheme of first selectable color pallet 628A, and in turn making the associated layer having the corresponding color gradient 730 visible to overlay, cover, and/or visual replace the single-gray color scheme of the visual object 902 in master image file 922 with the plurality of colors included in color gradient 730 for first selectable color pallet 628A.

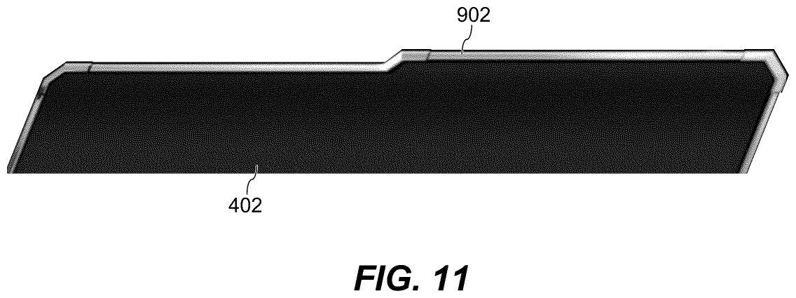

FIG. 11 is an example illustration of two distinct visual objects 402, 902 after reskinning. More specifically, FIG. 11 is an illustration of visual object 402 discussed herein with respect to FIGS. 5A-8, and distinct visual object 902 discussed herein with respect to FIGS. 9A-10 subsequent to reskinning each of the visual objects, 402, 902. As shown, and at least in part because of distinct visual enhancements (e.g., tint-effect layer, gradient map layer) included in respective master image files 522, 922 (see, FIGS. 5B and 9B), each visual object 402, 902 includes a distinct color or pallet-specific color scheme after reskinning. Additionally, or alternatively, each visual object 402, 902 can include distinct color(s) or pallet-specific color scheme after reskinning as a result of distinctly defined materials for each visual object 402, 902, distinct color properties, the type of object (e.g., base object v. frame object), and the like.

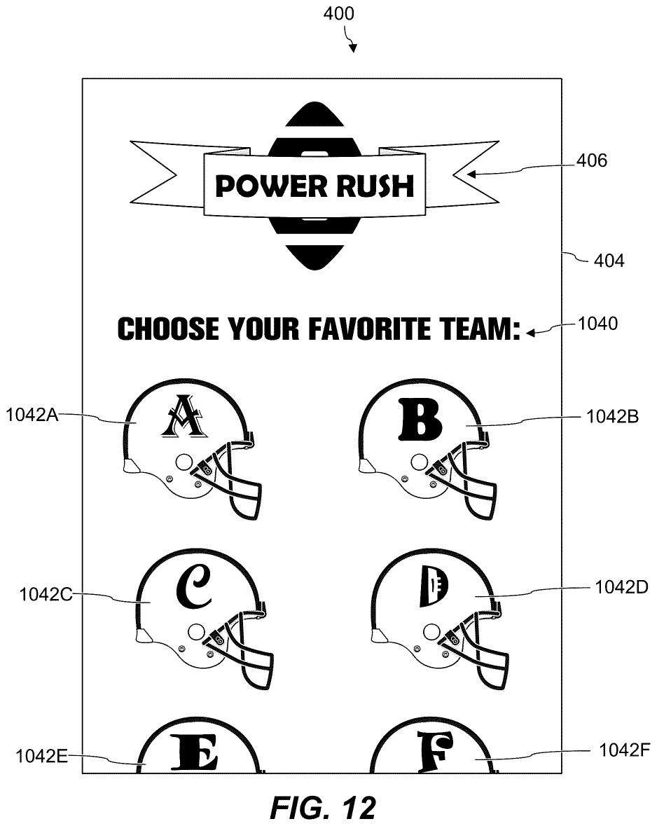

Referring to FIGS. 12-15, exemplary user interfaces or screenshots of a sequence of interacting with and/or playing electronic game 400 are displayed. In FIG. 12, display device 404 displays a “TEAM SELECTION” screen or triggering event 1040 for electronic game 400. For example, when a player of electronic game 400 first initiates electronic game 400 (e.g., opens app on mobile gaming device 256), the player is presented with triggering event 1040. As shown, a plurality of selectable, team helmets 1042 are presented to the player on display device 404. As discussed herein, each of the team helmets 1042 are associated with a preferred team, and in turn, one of the plurality of selectable color pallets 628 defined by single atlas 626 (see, FIG. 6A), a group of color pallets 628 included in single atlas 626, and/or hex color(s) 629 defined by single set 627 (see, FIG. 6B). For example, first selectable color pallet 628A and hex colors 629A are each associated with and/or corresponds to team helmet 1042A, while each of team helmets 1042B-1042F are associated within a distinct color pallet 628 of the plurality of color pallets 628 defined by single atlas 626, as well as distinct hex colors 629 of the plurality of hex colors included in single set 627. In another exemplary embodiment, a first group of color pallets 628, 628A included in a first row (R) of single atlas 626 and hex colors 629A are associated with and/or corresponds to team helmet 1042A, while each of team helmets 1042B-1042F are associated within a distinct groups of color pallets 628 included in each row (R) in single atlas 626, as well as distinct hex color(s) 629 of the plurality of hex colors included in single set 627.

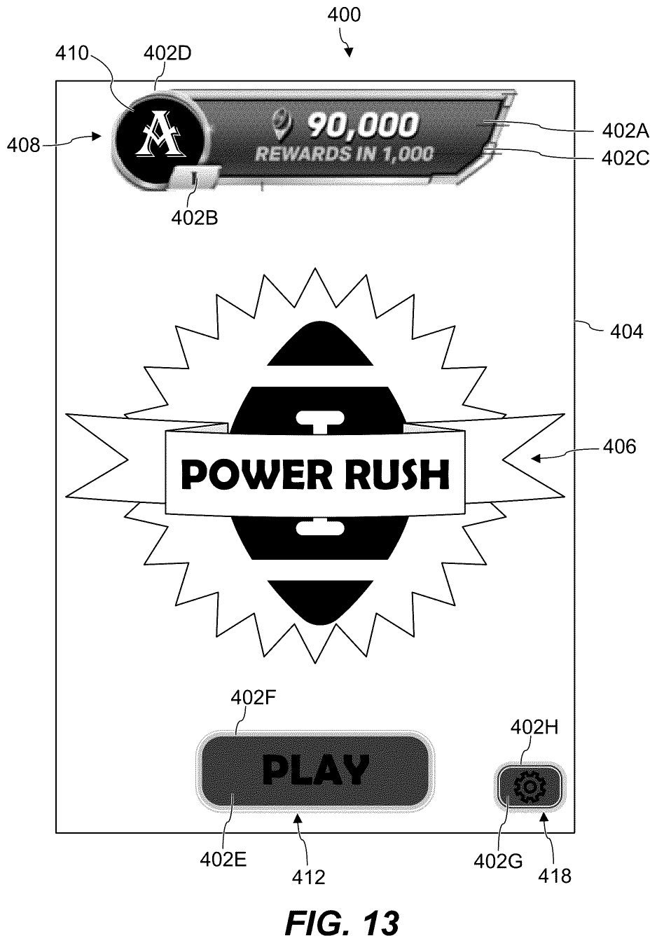

Based on a player selecting (e.g., touching, tapping) one of the plurality of team helmets 1042 displayed on display device 404 during the triggering event 1040, electronic game 400 may commence and visual objects 402A-402H of electronic game 400 may be reskinned using processes discussed herein. For example, and comparing FIG. 4 with FIG. 13, after the player of electronic game 400 selects team helmet 1042A, electronic game 400 is displayed on display device 404. Each of the plurality of visual objects 402A-402H of electronic game 400 have also been reskinned and/or adjusted from the single color scheme (see, FIG. 5A) or grayscale gradient map (see, FIG. 9B) to the pallet-specific color scheme associated with first selectable color pallet 628A and/or hex colors 629A, as shown in FIG. 13. More specifically, visual objects 402A, 402E, 402G (e.g., base objects) are reskinned to display, depict, and/or present first (primary) color 732 included in hex colors 629A defined in single set 627 of hex colors 629 (see, FIG. 6B). Additionally, visual objects 402B, 402D, 402F, 402H (e.g., frame objects) are reskinned to display, depict, and/or present each of the plurality of colors defined by gradient 730 for first selectable color pallet 628A. Visual object 402C is reskinned to display, depict, and/or present second (secondary) color 734 included in hex colors 629A defined in single set 627 of hex colors 629. In non-limiting examples, each of visual object 402A-402H displayed in electronic game 400 is reskinned based on the adjusting, changing, and/or making visible layers associated with layer comps included in the master image file associated with each individual visual object 402A-402H, as similarly discussed herein.

In another exemplary embodiment, each of the plurality of visual objects 402A-402H of electronic game 400 are reskinned and/or adjusted from the single color scheme (see, FIG. 5A) or grayscale gradient map (see, FIG. 9B) to one of a group of color pallets 628 included in single atlas 626 and/or hex color(s) 629A. For example, visual objects 402A, 402E, 402G (e.g., base objects) are reskinned to display, depict, and/or present first (primary) color 732 included in hex colors 629A defined in single set 627 of hex colors 629 (see, FIG. 6B). Visual object 402B is reskinned to display, depict, and/or present each of the plurality of colors defined by gradient 730 for a selectable color pallet 628A including in a group of color pallets 628, 628A and defined in the first row (R) of single atlas 626 (see, FIG. 6A). Visual object 402B is reskinned using color pallet 628A as a result of the group of color pallets 628 defined in the first row (R) of single atlas 626 being associated with team helmet 1042A (e.g., triggering event) and visual object 402B corresponding to the first column (C) in single atlas 626. Similarly in the exemplary embodiment, visual object 402C is reskinned using a distinct color pallet 628 included in the group of color pallets 628, 628A and defined in the first row (R) of single atlas 626 (see, FIG. 6A), while visual object 402F is reskinned using yet another color pallet 628 included in the group of color pallets 628, 628A and defined in the first row (R) of single atlas 626.

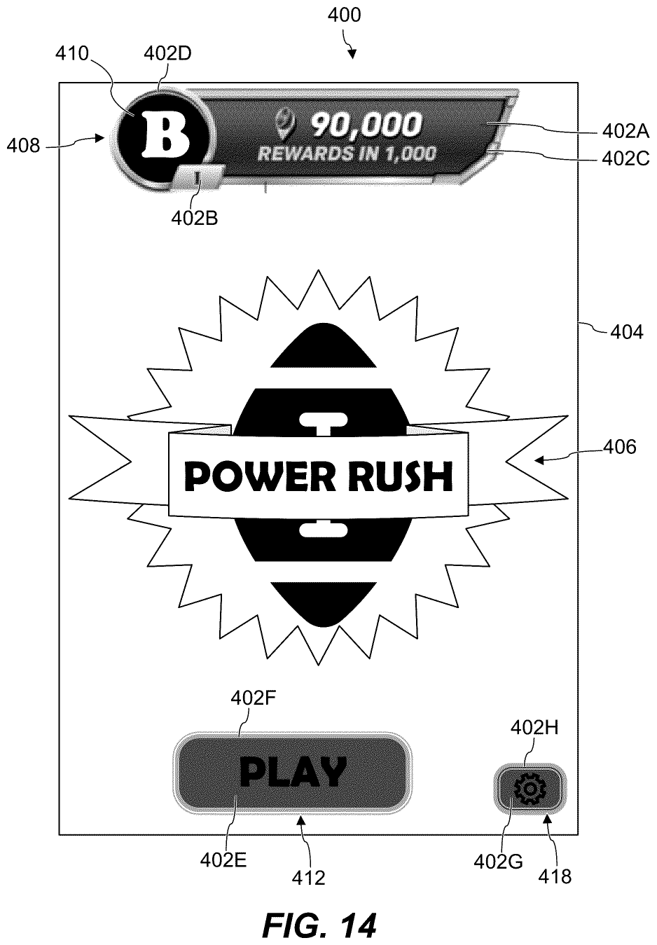

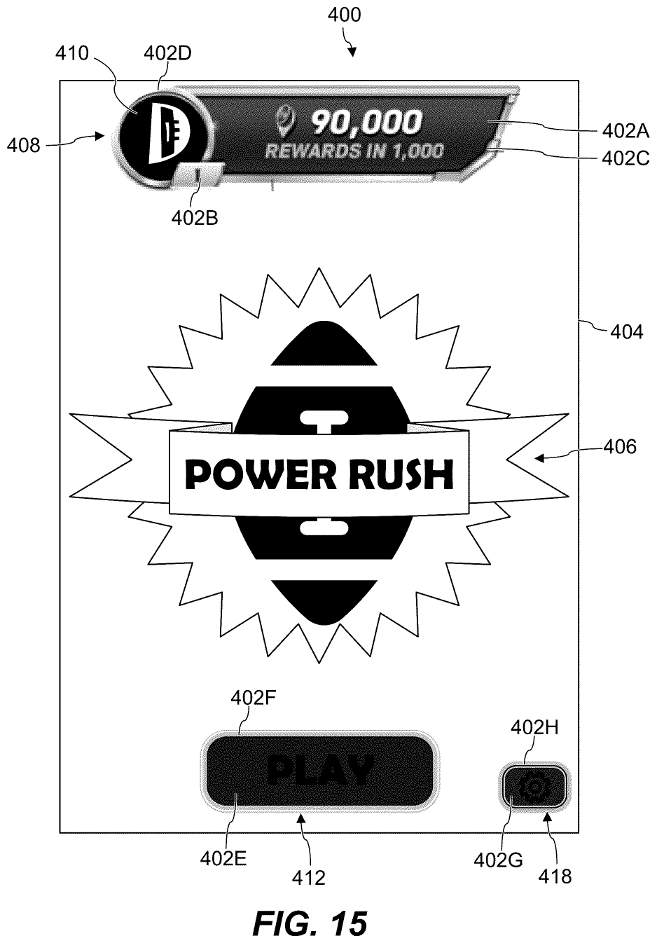

In an exemplary embodiment, and in response to closing, ending, and/or exiting electronic game 400 (e.g., tapping settings button 418), the player of electronic game 400 may be again presented with “TEAM SELECTION” screen or triggering event 1040 for electronic game 400 including the plurality of team helmets 1042. Additionally, exiting electronic game 400 may also result in each visual object 402A-402H being reverted back to the single color scheme and/or the grayscale gradient map. That is, exiting electronic game 400 may reverse, undue, and/or change back each visual object 402A-402H included in electronic game 400 from the pallet-specific color scheme associated with the selectable color pallet 628 (e.g., first selectable color pallet 628A), a group of color pallets 628 included in single atlas 626, and/or hex colors 629 (e.g., hex colors 629A) to the single color scheme and/or grayscale gradient map included in master image file for each visual object 402A-402H prior to reskinning. In additional exemplary embodiments each visual object 402A-402H may not be reverted back to the single color scheme and/or grayscale gradient map in response to closing and/or exiting electronic game 400. Rather, visual objects 402A-402H maintain the previously selected pallet-specific color pallet 628, the group of color pallets 628 included in single atlas 626, and/or hex color(s) 629 until a subsequent triggering event 1040 occurs (e.g., selecting a new team via settings button 418). After the subsequent triggering event 1040, the previously selected, adjusted, and/or displayed pallet-specific color pallet 628, group of color pallets 628 included in single atlas 626, and/or hex color(s) 629 for visual objects 402A-402H are replaced and/or adjusted with the newly selected pallet-specific color scheme (see e.g., FIGS. 14 and 15), prior to the displaying of visual objects 402A-402H with the newly selected and/or adjusted, pallet-specific color pallet 628, group of color pallets 628 included in single atlas 626, and/or hex color(s) 629.

As shown in FIG. 14, after the player of electronic game 400 is once again presented with triggering event 1040 and selects team helmet 1042B, electronic game 400 is displayed on display device 404. Each of the plurality of visual objects 402A-402H of electronic game 400 are also reskinned and/or adjusted from the single color scheme (see, FIG. 5A) and/or grayscale gradient map (see, FIG. 9B) to the pallet-specific color scheme associated with a distinct selectable color pallet 628 defined in single atlas 626 and/or hex color(s) 629 associated with a distinct, selectable hex color(s) defined by single set 627, as shown in FIG. 14. With comparison to FIG. 13, each visual object 402A-402H of electronic game 400 displayed in FIG. 14 includes a distinct hex color, distinct color gradient, and/or distinct pallet-specific color scheme. FIG. 15 shows yet another exemplary user interface or screenshot of electronic game 400 after the player selects helmet 1042D during triggering event 1040. With comparison to electronic game 400 shown in both FIGS. 13 and 14, visual objects 402A-402H displayed in FIG. 15 are reskinned and/or adjusted to the pallet-specific color scheme associated with a distinct selectable color pallet 628 defined in single atlas 626 and/or hex color(s) 629 defined by single set 627, and associated with team helmet 1042D. As such, the hex color(s), color gradient, and/or pallet-specific color scheme included on reskinned visual objects 402A-402H is distinct from the hex color(s), color gradient, and/or pallet-specific color schemes displayed in FIGS. 13 and 14, respectively.

In another exemplary embodiment, each of the plurality of visual objects 402A-402H displayed in FIGS. 14 and 15 are reskinned and/or adjusted from the single color scheme (see, FIG. 5A) or grayscale gradient map (see, FIG. 9B) to one of a group of color pallets 628 included in single atlas 626 and/or hex color(s) 629A. That is, visual objects 402A-402H are reskinned to display, depict, and/or present a hex colors 629 defined in single set 627 of hex colors 629 (see, FIG. 6B), or alternatively a plurality of colors defined by gradient 730 for color pallet 628 including in a group of color pallets 628 defined in a single row (R) of single atlas 626 (see, FIG. 6A). The single color pallet 628 included the group of color pallets 628 used to reskin each visual object 402A-402H is selected and/or dependent upon the column (C) in single atlas 626 that corresponds to each individual visual object 402A-402H, as discussed herein.

In non-limiting examples, each of visual object 402A-402H displayed in electronic game 400 is reskinned based on the adjusting, changing, and/or made visible layers associated with layer comps included in the master image file associated with each individual visual object 402A-402H, as similarly discussed herein. That is, although hex color(s), color gradients, and/or pallet-specific color schemes are based on distinct selectable color pallets 628 and/or hex color(s) 629 associated with distinct triggering events (e.g., selecting distinct team helmets 1042), each visual object 402A-402H displayed in electronic game 400 is based on the reskinning of a single master image file (e.g., master image file 522) including a single color scheme and/or grayscale gradient map.

Utilizing processes and computer-programs (e.g., Adobe Photoshop®) described herein to reskin visual object 402 reduces the size and/or number of files required by electronic game 400 to provide players selectable options to vary the visuals or UI of electronic game 400 during gameplay. That is, the processes of reskinning visual object 402 and/or the use of layers in a single master image file 522, allows for various objects in electronic game 400 to be reskinned and/or display a variety of selectable colors or color schemes, without the need to create individual image files having distinct colors for each object. Traditionally, each visual object 402 would require its own image file for each selectable color pallet 628 and/or hex color 629. In this respect, where thirty (30) distinct color pallets 628 and/or hex color(s) 629 are offered in electronic game 400, a single visual object 402 that is approximately 25 kilobytes (KB) in size would require 30 separate files to cover each distinct color pallet—totaling approximately 750 KB. Conversely, using the reskinning processes discussed herein, and utilizing single master image file 522 including the single color scheme and/or grayscale gradient map, which is approximately 2 KB in size, would only require a total of approximately 60 KB to cover each distinct color pallet 628 and/or hex color(s) 629 in electronic game 400. The size of single master image file 522 is significantly reduced (e.g., 2 KB v. 25KB) when compared to traditional files because the single master image file 522 includes a single, gray color scheme and/or visual enhancements 524, 924 (e.g., tint, gradient map), rather than one or more colors.

Furthermore in exemplary embodiments, each visual object 402 is exported in electronic game 400 separate from single atlas 626 defining selectable color pallets 628 and single set 627 defining hex colors 629. That is, the files defining single atlas 626 and/or single set 627 are stored separately from master image files (e.g., master image files 522, 922) including visual objects 402 having a single color scheme and/or grayscale gradient map. In non-limiting examples, single atlas 626/single set 627 may be stored in a backend of the memory device included in mobile gaming device 256, such that specific color pallets 628 defined in single atlas 626, a predefined group of color pallets 628 (e.g., single row (R) of color pallets 628 within single atlas 626), and/or hex colors 629 included in single set 627 selected during the triggering event of electronic game 400 are pushed on an “as needed” or “on-demand basis.” Moreover, and as a result of the reduced file size and/or number of files used in electronic game 400 including reskinnable visual objects 402, transferring data relating to specific color pallets 628, a specific group of color pallets 628, and/or hex colors 629 stored in a backend of the memory device included in mobile gaming device 256 can occur near instantaneously and/or with minimal to no load time for reskinning visual objects 402. For example, when a team is selected during electronic game 400, the devices and/or systems running electronic game 400 may only pull, request, and/or receive data from the backend of the memory device relating to a single color pallet 628, one group of color pallets 628, and/or hex colors 629 that are associated or correspond to the selected team.

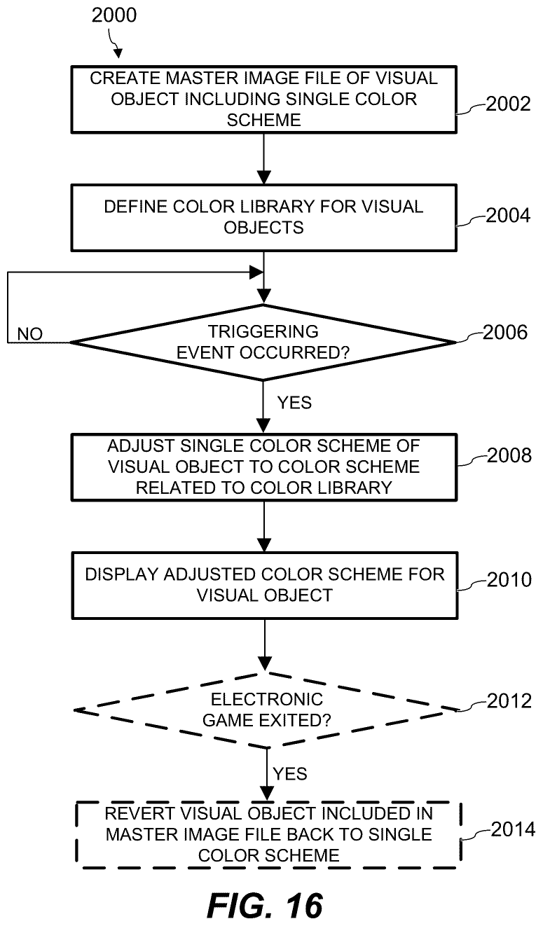

FIG. 16 illustrates an example method 2000 of reskinning visual objects displayed in electronic games. The visual objects can include any number of objects displayed during gameplay of electronic games.

In process 2002, a master image file of the visual object is created. That is, a master image file is created, generated, and/or produced for each visual object included in the electronic game. The visual object included in the created master image file includes a single color scheme (e.g., single-gray color) and at least one visual enhancement. In non-limiting examples, creating the master image file of the visual object can further include creating a vector shape of the visual object, and creating at least one visual enhancement layer over and/or on top of the created vector shape of the visual object. The created visual enhancement layer(s) defines the visual enhancement of the visual object included in the created master image file. Additionally, creating the visual enhancement layer(s) for the created vector shape of the visual object can also include creating a tint-effect layer over the created vector shape of the visual object including the single-gray color scheme, and/or creating a gradient map layer over the created vector shape of the visual object.

In process 2004 at least one color library for the visual object is defined. The color library includes a plurality of colors, where at least one color of the plurality of colors are associated with a triggering event within the electronic game. In exemplary embodiments, defining color library(ies) includes defining a plurality of selectable color pallets for the visual object included a single atlas, and/or defining a plurality of hex colors for the visual object in a single set of hex colors. A single atlas includes, define, and/or comprises a plurality of selectable color pallets for the visual object. Each of the selectable color pallets include at least one color and are associated with a triggering event within the electronic game. In a non-limiting example, the at least one color of each of the plurality of selectable color pallets included in the single atlas includes a color gradient. Additionally in exemplary embodiments, at least one hex color of the plurality of hex colors is associated with a triggering event within the electronic game.

In process 2006, it is determined if a triggering event occurred within the electronic game including the visual object. In non-limiting examples, the triggering event can include selecting an option or preference associated with one of the plurality of selectable color pallets defined in the single atlas and/or at least one of the hex colors included in the single set of hex colors. In response to determining that the triggering event did occur (e.g., “YES” at 2006), the method proceeds to process 2008.

In process 2008, the single-gray color scheme of the visual object included in the created master image file is adjusted. More specifically, the single color scheme of the visual object is adjusted, changed, modified, and/or altered to a color scheme relating to the at least one color of the plurality of colors included in the defined color library. In exemplary embodiments, adjusting the single-gray color scheme of the visual object includes identifying one selectable color pallet of the plurality of selectable color pallets included in the single atlas and associated with the triggering event, and subsequently changing the single-gray color scheme of the visual object to the one, identified selectable color pallet in response to the created vector shape of the visual object including the gradient map layer. The identified, selectable color pallet includes a color gradient defined in the single atlas. In other exemplary embodiments, adjusting of the single-gray color scheme of the visual object included in the created master image file includes identifying the at least one hex color of the plurality of hex colors included in the single set of hex colors and associated with the triggering event within the electronic game, and changing the single-gray color scheme of the visual object to the at least one identified hex color in response to the created vector shape of the visual object including the tint-effect layer.

In process 2010, the adjusted color scheme for the visual object in the electronic game is displayed. More specifically, the visual object including the newly adjusted, color scheme including a hex color and/or the selected color pallet is displayed, depicted, and/or presented in the electronic game.

In process 2012, shown in phantom as optional, it is determined if the electronic game is exited. More specifically, in process 2012 it is determined if the player of the electronic game has exited the game, closed the game, and/or opted to select another triggering event for the electronic game. In response to determining that the game was not exited (e.g., “NO” at 2012), the electronic game may continue to display the visual object including the adjusted color scheme. However, in response to determining that the electronic game was exited and/or closed (e.g., “YES” at 2012), the method proceeds to process 2014.

In process 2014, shown in phantom as optional, the visual object included in the master image file is reverted back to the single-gray cover scheme. That is, visual object is re-adjusted, re-altered, and/or subsequently modified to remove the color scheme. As such, visual object is reverted back to including the single-gray color scheme created in the master image file of the visual object. In other exemplary embodiments, the visual object is not reverted back to the single-gray color scheme in response to closing and/or exiting the game. Rather, the visual objects maintain the previously selected and/or adjusted color scheme until a subsequent triggering event occurs (e.g., process 2006). After the subsequent triggering event, the previously selected, adjusted, and/or displayed color scheme for the visual object is replaced and/or adjusted with the newly selected color scheme (e.g., process 2008), prior to the displaying of the visual object with the newly selected and/or adjusted color scheme.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A method for reskinning a visual object displayed in an electronic game, the method comprising:
creating a master image file of the visual object, the visual object included in the created master image file including: (i) a single-gray color scheme, and (ii) at least one visual enhancement;
defining at least one color library for the visual object, the color library including a plurality of colors, at least one color of the plurality of colors associated with a triggering event within the electronic game;
in response to determining the triggering event associated with the at least one color of the plurality of colors included in the color library occurred during the electronic game, adjusting the single-gray color scheme of the visual object included in the created master image file to a color scheme for the visual object, the color scheme including the at least one color of the plurality of colors included in the color library; and
displaying the adjusted, color scheme for the visual object in the electronic game.

2. The method of claim 1, wherein the creating of the master image file of the visual object further comprises:
creating a vector shape of the visual object; and
creating at least one visual enhancement layer over the created vector shape of the visual object, the created at least one visual enhancement layer defining the at least one visual enhancement of the visual object included in the created master image file.

3. The method of claim 2, wherein the creating of the at least one visual enhancement layer for the created vector shape of the visual object further comprises at least one of:
creating a tint-effect layer over the created vector shape of the visual object including the single-gray color scheme; and
creating a gradient map layer over the created vector shape of the visual object including the single-gray color scheme.

4. The method of claim 3, wherein the defining of the at least one color library for the visual object further comprises at least one of:
defining a plurality of selectable color pallets for the visual object included a single atlas, one selectable color pallet of the plurality of selectable color pallets associated with the triggering event within the electronic game; and
defining a plurality of hex colors for the visual object in a single set of hex colors, at least one hex color of the plurality of hex colors associated with the triggering event within the electronic game.

5. The method of claim 4, wherein the adjusting of the single-gray color scheme of the visual object included in the created master image file further comprises:
identifying the one selectable color pallet of the plurality of selectable color pallets included in the single atlas and associated with the triggering event; and
changing the single-gray color scheme of the visual object to the one, identified selectable color pallet in response to the created vector shape of the visual object including the gradient map layer.

6. The method of claim 4, wherein the adjusting of the single-gray color scheme of the visual object included in the created master image file further comprises:
identifying the at least one hex color of the plurality of hex colors included in the single set of hex colors and associated with the triggering event within the electronic game; and
changing the single-gray color scheme of the visual object to the at least one identified hex color in response to the created vector shape of the visual object including the tint-effect layer.

7. The method of claim 1, further comprising:
in response to exiting the electronic game including the visual object having the adjusted color scheme, reverting the visual object included in the created master image file back to the single-gray color scheme;
in response to determining a distinct triggering event associated with a distinct, at least one color of the plurality of colors included in the color library occurred after exiting the electronic game, adjusting the single-gray color scheme of the visual object included in the created master image file to a distinct color scheme for the visual object, the distinct color scheme associated with the distinct, at least one color of the plurality colors included in the color library; and
displaying the adjusted, distinct color scheme for the visual object in the electronic game.

8. A non-transitory computer-readable storage medium with instructions stored thereon that, in response to execution by at least one processor, cause the at least one processor to:
create a master image file of a visual object displayed in an electronic game, the visual object included in the created master image file including: (i) a single-gray color scheme, and (ii) at least one visual enhancement;
define at least one color library for the visual object, the color library including a plurality of colors, at least one color of the plurality of colors associated with a triggering event within the electronic game;
in response to determining the triggering event associated with the at least one color of the plurality of colors included in the color library occurred during the electronic game, adjust the single-gray color scheme of the visual object included in the created master image file to a color scheme for the visual object, the color scheme including the at least one color of the plurality of colors included in the color library; and
display the adjusted, color scheme for the visual object in the electronic game.

9. The non-transitory computer-readable storage medium of claim 8, wherein the creating of the master image file of the visual object further causes the at least one processor to:
create a vector shape of the visual object; and
create at least one visual enhancement layer over the created vector shape of the visual object, the created at least one visual enhancement layer defining the at least one visual enhancement of the visual object included in the created master image file.

10. The non-transitory computer-readable storage medium of claim 9, wherein the creating of the at least one visual enhancement layer for the created vector shape of the visual object further causes the at least one processor to at least one of:
create a tint-effect layer over the created vector shape of the visual object including the single-gray color scheme; and
create a gradient map layer over the created vector shape of the visual object including the single-gray color scheme.

11. The non-transitory computer-readable storage medium of claim 10, wherein the defining of the at least one color library for the visual object further causes the at least one processor to at least one of:
define a plurality of selectable color pallets for the visual object included a single atlas, one selectable color pallet of the plurality of selectable color pallets associated with the triggering event within the electronic game; and
define a plurality of hex colors for the visual object in a single set of hex colors, at least one hex color of the plurality of hex colors associated with the triggering event within the electronic game.

12. The non-transitory computer-readable storage medium of claim 11, wherein the adjusting of the single-gray color scheme of the visual object included in the created master image file further causes the at least one processor to:
identify the one selectable color pallet of the plurality of selectable color pallets included in the single atlas and associated with the triggering event; and
change the single-gray color scheme of the visual object to the one, identified selectable color pallet in response to the created vector shape of the visual object including the gradient map layer.

13. The non-transitory computer-readable storage medium of claim 11, wherein the adjusting of the single-gray color scheme of the visual object included in the created master image file further causes the at least one processor to:
identify the at least one hex color of the plurality of hex colors included in the single set of hex colors and associated with the triggering event within the electronic game; and
change the single-gray color scheme of the visual object to the at least one identified hex color in response to the created vector shape of the visual object including the tint-effect layer.

14. The non-transitory computer-readable storage medium of claim 8, wherein the instructions, when executed, further cause the at least one processor to:
in response to exiting the electronic game including the visual object having the adjusted color scheme, revert the visual object included in the created master image file back to the single-gray color scheme;
in response to determining a distinct triggering event associated with a distinct, at least one color of the plurality of colors included in the color library occurred after exiting the electronic game, adjust the single-gray color scheme of the visual object included in the created master image file to a distinct color scheme for the visual object, the distinct color scheme associated with the distinct, at least one color of the plurality colors included in the color library; and
display the adjusted, distinct color scheme for the visual object in the electronic game.

15. A system comprising:
at least one memory for storing instruction; and
a controller in communication with the at least one memory, the controller including at least one processor, wherein when the instructions are executed by the at least one processor, the at least one processor is configured to:
create a master image file of a visual object displayed in an electronic game, the visual object included in the created master image file including: (i) a single-gray color scheme, and (ii) at least one visual enhancement;
define at least one color library for the visual object, the color library including a plurality of colors, at least one color of the plurality of colors associated with a triggering event within the electronic game;
in response to determining the triggering event associated with the at least one color of the plurality of colors included in the color library occurred during the electronic game, adjust the single-gray color scheme of the visual object included in the created master image file to a color scheme for the visual object, the color scheme including the at least one color of the plurality of colors included in the color library; and
display the adjusted, color scheme for the visual object in the electronic game.

16. The system of claim 15, wherein the creating of the master image file of the visual object further causes the at least one processor to:
create a vector shape of the visual object; and
create at least one visual enhancement layer over the created vector shape of the visual object, the created at least one visual enhancement layer defining the at least one visual enhancement of the visual object included in the created master image file.

17. The system of claim 16, wherein the creating of the at least one visual enhancement layer for the created vector shape of the visual object further causes the at least one processor to at least one of:
create a tint-effect layer over the created vector shape of the visual object including the single-gray color scheme; and
create a gradient map layer over the created vector shape of the visual object including the single-gray color scheme.

18. The system of claim 17, wherein the defining of the at least one color library for the visual object further causes the at least one processor to at least one of:
define a plurality of selectable color pallets for the visual object included a single atlas, one selectable color pallet of the plurality of selectable color pallets associated with the triggering event within the electronic game; and
define a plurality of hex colors for the visual object in a single set of hex colors, at least one hex color of the plurality of hex colors associated with the triggering event within the electronic game.

19. The system of claim 18, wherein the adjusting of the single-gray color scheme of the visual object included in the created master image file further causes the at least one processor to:
identify the one selectable color pallet of the plurality of selectable color pallets included in the single atlas and associated with the triggering event; and
change the single-gray color scheme of the visual object to the one, identified selectable color pallet in response to the created vector shape of the visual object including the gradient map layer.

20. The system of claim 18, wherein the adjusting of the single-gray color scheme of the visual object included in the created master image file further causes the at least one processor to:
identify the at least one hex color of the plurality of hex colors included in the single set of hex colors and associated with the triggering event within the electronic game; and
change the single-gray color scheme of the visual object to the at least one identified hex color in response to the created vector shape of the visual object including the tint-effect layer.
